(19) United States
(12) Patent Application Publication
(10) Pub. No.: US 2008/0193845 A1
(43) Pub. Date: Aug. 14, 2008

(54) NONAQUEOUS ELECTROLYTE SECONDARY BATTERY

(76) Inventors: Yoshiyuki MURAOKA, Osaka (JP); Yukihiro Okada, Osaka (JP)

Correspondence Address: MCDERMOTT WILL & EMERY LLP, 600 13TH STREET, NW, WASHINGTON, DC, 20005-3096, US

(21) Appl. No.: 12/029,712

(22) Filed: Feb. 12, 2008

(30) Foreign Application Priority Data
Feb. 14, 2007 (JP) 2007-032948

(51) Int. Cl. H01M 4/52; H01M 4/46; H01M 4/58; H01M 2/16; H01M 4/50

(52) U.S. Cl. 429/223; 429/231.6; 429/231.5; 429/224; 429/246

(57) ABSTRACT

A nonaqueous electrolyte secondary battery includes a positive electrode, a negative electrode, a porous insulating layer, and a nonaqueous electrolyte. The positive electrode contains, as a positive electrode active material, a phosphoric compound having an olivine structure and expressed by a general formula of Li_{z}Fe_{1-y}X_{y}PO₄ (0≦y≦0.3, 0<z≦1) (X is one of metals selected from the group consisting of Nb, Mg, Ti, Zr, Ta, W, Mn, Ni, and Co). The negative electrode contains, as a negative electrode active material, a material capable of occluding and extracting lithium ion. The nonaqueous electrolyte is retained between the positive electrode and the negative electrode. The porous insulating layer is provided between the positive electrode and the negative electrode and contains metal oxide. The volume ratio of the metal oxide to the porous insulating layer is in the range between 15 vol % and 50 vol %, both inclusive.

### BACKGROUND OF THE INVENTION

1. Field of the Invention

The present invention relates to nonaqueous electrolyte secondary batteries, such as a lithium ion secondary battery and particularly relates to a nonaqueous electrolyte secondary battery containing a phosphoric compound having an olivine structure (hereinafter referred to it merely as “olivine oxide”) as a positive electrode active material.

2. Description of Related Art

Nonaqueous electrolyte secondary batteries (dominantly, lithium ion secondary batteries), which can attain high energy density at high voltage, are utilized as main power sources for mobile tools, such as mobile communication tools, mobile electronic tools, and the like. Recently, with a view to preventing environmental destruction, the use of the nonaqueous electrolyte secondary batteries are being examined as power sources boarded on automobiles and backup power sources. Besides, the direct current is desired in large-size appliances. In short, high-power, compact, and light-weight lithium ion second batteries are desired.

In general, when a lithium ion secondary battery is left in a high temperature state caused by heat generation caused due to external short circuit or internal short circuit in overcharge or the like, thermal runaway is caused in the lithium ion secondary battery. Particularly, since the thermal runaway is remarkable in large-size lithium ion secondary batteries, care should be taken for upsizing the lithium ion secondary batteries.

A dominant factor of causing the thermal runaway in a lithium ion secondary battery left in a high temperature state is that the high temperature state causes the positive electrode active material to be unstable. In detail, oxygen contained in the positive electrode active material (composite oxide of lithium and metal other than lithium is used as the positive electrode active material for a nonaqueous electrolyte secondary battery in general) might be extracted in a high temperature state, so that the active oxygen reacts with the electrolytic and the like, thereby generating heat in chain. Accordingly, the use of a positive electrode active material made of a material from which oxygen is less extracted even in a high temperature state might prevent thermal runaway, and olivine oxide containing Li has been proposed as a positive electrode active material (see Japanese Unexamined Patent Application Publication No. 2002-216770). In such olivine oxide, oxygen, which is bonded with phosphorous strongly, might be present stably without being extracted from the olivine oxide even in a high temperature state.

On the other hand, it has been tried to secure the safety in overcharge of the nonaqueous electrolyte secondary batteries by providing a PTC (positive temperature coefficient) thermistor inside the batteries. In the case where a nonaqueous electrolyte secondary battery is used as a high power battery, however, safety components, such as the PTC thermistor and the like must be excluded in order to reduce the resistance. For this reason, the high-power output nonaqueous electrolyte secondary battery includes a CID (current interrupt device) and a separator, in addition, having a shutdown function. The CID is a metal-made component for interrupting a current path upon rise in internal pressure of the battery. The factor of the rise in internal pressure in the battery is that, for example, the electrolyte is dissolved in overcharge to generate gas. The shutdown function of the separator means a function of interrupting the current by solving the separator at a temperature below the thermal decomposition temperature of the positive or negative electrode.

### SUMMARY OF THE INVENTION

As described above, with the use of the olivine oxide as the positive electrode active material, oxygen extraction from the positive electrode active material can be suppressed when compared with the case using lithium cobalt oxide as the positive electrode active material. It was found, however, that the thermal runaway is caused even with the olivine oxide.

In view of the foregoing, the present invention enhances the safety of the battery in a high temperature state even with the use of the olivine oxide as the positive electrode active material.

Specifically, a nonaqueous electrolyte secondary battery in accordance with the present invention includes: a positive electrode containing, as a positive electrode active material, a phosphoric compound having an olivine structure and expressed by a general formula of Li_{z}Fe_{1-y}X_{y}PO₄ (0≦y≦0.3, 0<z≦1) (X is one of metals selected from the group consisting of Nb, Mg, Ti, Zr, Ta, W, Mn, Ni and Co); a negative electrode containing, as a negative electrode active material, a material capable of occluding and discharging lithium ion; a nonaqueous electrolyte retained between the positive electrode and the negative electrode; and a porous insulating layer provided between the positive electrode and the negative electrode and containing metal oxide. The volume ratio of the metal oxide to the porous insulating layer is in the range between 15 vol % and 50 vol %, both inclusive.

In the following preferred embodiment, the porous insulating layer is a metal oxide layer made of the metal oxide. In the present specification, the metal oxide layer made of the metal oxide includes not only the porous layer containing only the metal oxide but also a porous layer containing a binder for binding adjacent particles of the metal oxide together.

In the following preferred embodiments, the porous insulating layer contains the metal oxide and an organic material, wherein the melting point of the metal oxide is higher than the melting point of the organic material. In this case, the porous insulating layer may have a layered structure of a metal oxide layer made of the metal oxide and a separator made of the organic material or may be formed of the metal oxide and the organic material which are mixed with each other.

In the nonaqueous electrolyte secondary battery in accordance with the present invention, the metal oxide layer is preferably formed of a plurality of particles of the metal oxide bound together.

In the nonaqueous electrolyte secondary battery in accordance with the present invention, the metal oxide layer may be provided on a surface of at least one of the positive electrode and the negative electrode.

In the nonaqueous electrolyte secondary battery in accordance with the present invention, the metal oxide is preferably aluminum oxide.

### BRIEF DESCRIPTION OF THE DRAWINGS

FIG. 1 is a graph showing respective temperature characteristics and respective characteristics of lithium cobalt oxide and olivine oxide.

FIG. 2 is a vertical sectional view of a lithium ion secondary battery in accordance with the present embodiment.

FIG. 3 is an enlarged view of an electrode group of the lithium ion secondary battery in accordance with the present embodiment.

FIG. 4 is an enlarged view of an electrode group of a lithium ion secondary battery in accordance with Modified Example 1 of the present embodiment.

FIG. 5 is an enlarged view of an electrode group of a lithium ion secondary battery in accordance with Modified Example 2 of the present embodiment.

### DESCRIPTION OF THE PREFERRED EMBODIMENTS

Prior to description of a preferred embodiment of the present invention, the logic that the present invention was accomplished will be described.

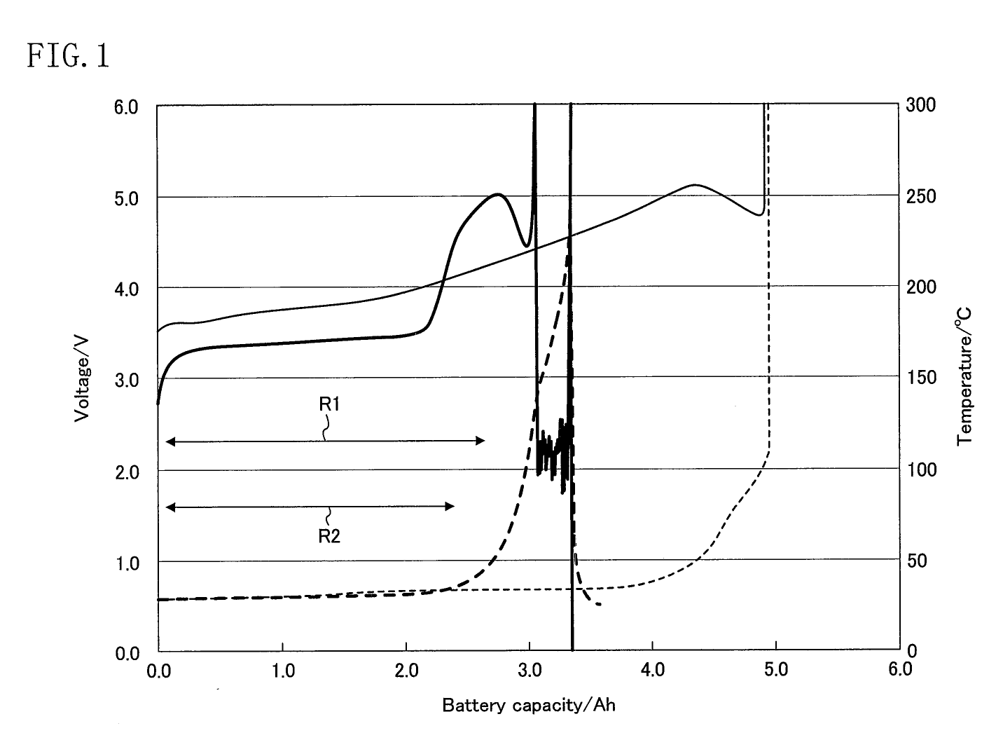

Conventionally, lithium cobalt oxide has been used as a positive electrode active material for a nonaqueous electrolyte secondary battery. In this case, a high temperature state caused by overcharge or the like causes decomposition reaction of the lithium cobalt oxide which accompanies oxygen generation, with a result that thermal runaway is liable to be caused. Olivine oxide causes no decomposition reaction accompanying oxygen generation even in a high temperature state caused by overcharge or the like, and accordingly, the use of the olivine oxide as the positive electrode active material might leads to provision of a comparatively highly safe nonaqueous electrolyte secondary battery. It was found first, however, that the following disadvantage is involved even with the use of the olivine oxide as the positive electrode active material. The disadvantages will be described below with reference to FIG. 1.

FIG. 1 indicates a voltage characteristic and a temperature characteristic in the case where the lithium cobalt oxide is used as the positive electrode active material and a voltage characteristic and a temperature characteristic in the case where the olivine oxide is used as the positive electrode active material. In FIG. 1, the fine lines indicate the characteristics in the case where lithium cobalt oxide is used as the positive electrode active material while the bold lines indicate in the case where the olivine oxide is used as the positive electrode active material. The solid lines indicate the voltage characteristics while the block lines indicate the temperature characteristics.

In the case where the lithium cobalt oxide is used as the positive electrode active material, the temperature of the lithium cobalt oxide is substantially constant within the battery capacity range not exceeding 4.0 Ah, but rises gradually when the battery capacity exceeds 5.0 Ah and abruptly rises from around 100° C. to around 250° C. The usable voltage of the lithium ion secondary battery using the lithium cobalt oxide as the positive electrode active material ranges from 2.5 V to 4.2 V, both inclusive, and it takes considerable time for the battery to generate heat after charge. Accordingly, in the case where, for example, the lithium ion secondary battery is boarded on a tool (a mobile phone or the like), if a protection circuit or the like incorporated in the tool stops charge of the lithium ion secondary battery upon sensing overcharge of the battery by the tool, heat generation of the lithium ion secondary battery can be suppressed.

On the other hand, it was found in the case where the olivine oxide is used as the positive electrode active material that, as shown in FIG. 1, the voltage is approximately 3.5 V at usual use, but rises in overcharge or the like abruptly from around 3.5 V to around 4.5 V. In general, the usable voltage of the lithium ion secondary battery using the olivine oxide as the positive electrode active material is in the range between 2.5 V and 3.8 V, both inclusive, and the voltage rises abruptly in a short period of time after charge. Abrupt voltage rise makes it difficult for the protection circuit or the like to stop charge to cause charge to last. As a result, much amount of Joule heat is generated to raise the temperature from 30° C. to over 200° C., for example.

Further, in general, the lithium ion secondary battery, which includes the CID as described above, has a mechanism (current interrupting mechanism) of physically interrupting the current and also has a separator shutdown function in case of failure of the CID. If the temperature rises abruptly as indicated in FIG. 1, the separator shutdown function and the current interrupting mechanism may not follow the temperature rise to be disabled. One example of the factors thereof might be quick charge. When the shutdown function and the current interrupting mechanism does not follow abrupt temperature rise to be disabled, the abrupt temperature rise cannot be stopped to melt the separator in the end. Melting of the separator causes the positive electrode and the negative electrode to be in contact with each other to invite short circuit between the positive electrode and the negative electrode, thereby further raising the temperature. Thus, the thermal runaway is caused in the lithium ion secondary battery.

In sum, though it has been though that the olivine oxide as the positive electrode active material suppresses oxygen extraction from the positive electrode active material to prevent the thermal runaway from being caused, it was found that an abnormal state caused by overcharge or the like causes spark in the battery even in the case where the olivine oxide is used as the positive electrode active material, which involves serious danger. It was further found that voltage over 3.5 V cannot be applied to the olivine oxide and that the usable range R2 of the olivine oxide is narrower than the usable range R1 of the lithium cobalt oxide.

In view of the foregoing, the present inventors have invented a safe nonaqueous electrolyte secondary battery even containing the olivine oxide as the positive electrode active material. Specifically, the present inventors found that provision of a metal oxide layer excellent in thermal resistance between the positive electrode and the negative electrode prevents the positive electrode and the negative electrode from being in contact with each other even when the temperature is abruptly raised by overcharge or the like, with a result that a nonaqueous electrolyte secondary battery capable of suppressing spark was invented.

The embodiment of the present invention will be described below in detail with reference to the accompanying drawings. It should be noted that the present invention is not limited to the following embodiment.

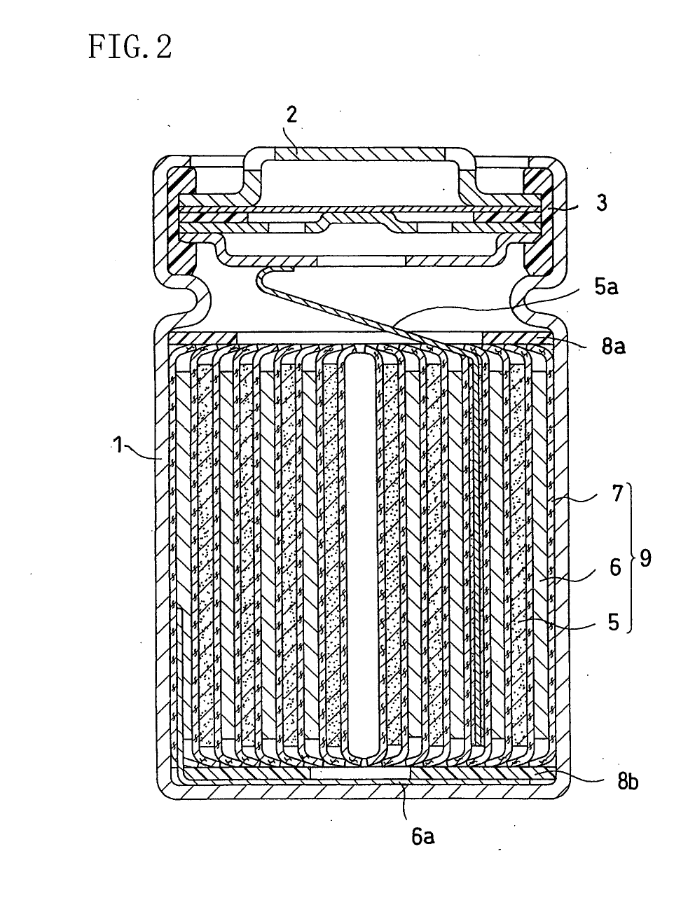

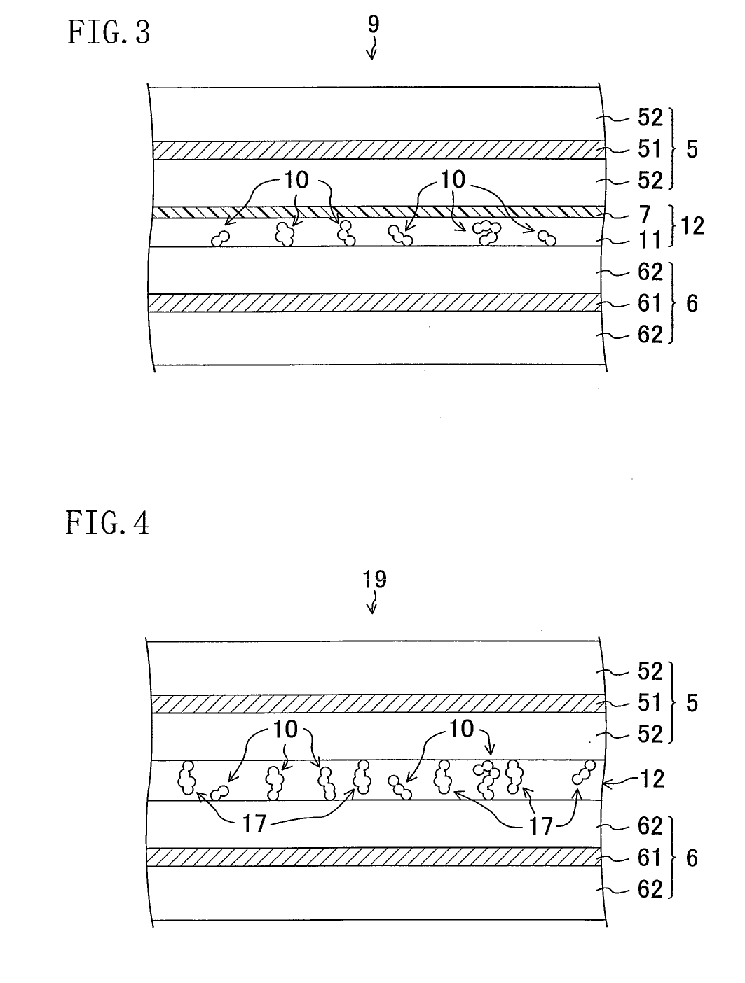

FIG. 2 is a vertical sectional view showing a structure of the nonaqueous electrolyte secondary battery in accordance with the present embodiment. FIG. 3 is an enlarged view schematically showing a structure of an electrode group in accordance with the present embodiment. In the present embodiment, a cylindrical lithium ion secondary battery is referred to as one example of the nonaqueous electrolyte secondary battery.

The lithium ion secondary battery in the present embodiment includes, as shown in FIG. 2, a battery case 1 made of, for example, stainless steel and an electrode group 9 accommodated in the battery case 1.

An opening is formed at the top of the battery case 1. A sealing plate 2 is calked at the opening with a gasket 3 interposed so as to seal the opening.

The electrode group 9 includes a positive electrode 5, a negative electrode 6, and a porous insulating layer 12, wherein the positive electrode 5 and the negative electrode 6 are wounded spirally with the porous insulating layer 12 interposed. A nonaqueous electrolyte (not shown) is retained between the positive electrode 5 and the negative electrode 6. An upper insulating plate 8a is arranged on the electrode group 9 while a lower insulating plate 8b is arranged below the electrode group 9.

One end of an aluminum-made positive electrode lead 5a is mounted at the positive electrode 5 while the other end thereof is connected to the sealing plate 2 serving as a positive electrode terminal. One end of a nickel-made positive electrode lead 6a is mounted at the positive electrode 6 while the other end thereof is connected to the battery case 1 serving as a negative electrode terminal.

The positive electrode 5 includes a positive electrode current collector 51 and a positive electrode mixture layer 52, as shown in FIG. 3. The positive electrode current collector 51 is a conductive plate member. The positive electrode mixture layer 52 is provided on each surface of the positive electrode current collector 51 and contains a positive electrode active material (not shown), wherein a binder, a conductive material, and the like are preferably contained in addition to the positive electrode active material. The positive electrode 5 is preferably produced in such a manner that positive electrode mixture slurry is prepared by mixing a positive electrode mixture containing the positive electrode active material with a liquid component and the thus prepared positive electrode mixture slurry is applied onto the positive electrode current collector 51 and is dried.

The positive electrode active material is olivine oxide expressed by a general formula of Li_{z}Fe_{1-y}X_{y}PO₄ (0≦y≦0.3, 0<z≦1) (X is one of metals selected from the group consisting of Nb, Mg, Ti, Zr, Ta, W, Mn, Ni, and Co). The olivine oxide allows oxygen to be less extracted even in a high temperature state and is, therefore, excellent in safety as a positive electrode active material for a lithium ion secondary battery.

The negative electrode 6 includes a negative electrode current collector 61 and a negative electrode mixture layer 62. The negative electrode current collector 61 is a conductive plate member. The negative electrode mixture layer 62 is provided on each surface of the negative electrode current collector 61 and contains a negative electrode active material (not shown), wherein a binder is preferably contained in addition to the negative electrode active material.

Metal, a carbon material, a tin compound, silicide, or any of various kinds of alloy materials may be used as the negative electrode active material, for example. The metal includes sole metal, an alloy, metal fiber, and the like. The carbon material includes various kinds of natural graphite, coke, carbon fiber, spherical carbon, various kinds of artificial graphite, amorphous carbon, and the like, for example. Wherein, as the negative electrode active material, one kind of the materials may be used solely or two or more kinds of the materials may be used in combination.

As the binder contained in the positive electrode mixture layer 52 and the positive electrode mixture layer 62, there is preferably used any of polytetrafluoroethylene, polyvinylidene fluoride, denatured polyvinylidene fluoride, tetrafluoroethylene-hexafluoropropylene copolymer (FEP: fluorinated-ethylene-propylene), fluororesin, such as polyvynilidienefluoride-hexafluoropropylene copolymer and the like, rubber particles of styrene butadiene rubber or the like, polyolefin-based resin, such as polyethylene and polypropylene, and the like, but the material is not limited specifically. As the conductive material contained in the positive electrode mixture layer 52, there are used any of carbon black, such as acetylene black, ketjen black, furnace black, lamp black, thermal black, and the like, graphite, carbon fiber, metal fiber, and the like.

A known compounding ratio can be applied to the compounding ratio of the active material, the conductive material, and the binder in the positive electrode mixture layer 52, and a known compounding ratio can be applied to the compounding ratio of the active material and the binder in the negative electrode mixture layer 62, as well.

A long porous or non-porous conductive substrate may be used as the current collectors. A stainless steel plate, an aluminum plate, a titanium plate, or the like is used as the positive electrode current collector 51, for example. On the other hand, a stainless steel plate, a nickel plate, a copper plate, or the like is used as the negative electrode current collector 61. Each thickness of the positive electrode current collector 51 and the negative electrode current collector 62 is preferably in the range between 1 μm and 500 μm, both inclusive, more preferably in the range between 5 μm and 20 μm, both inclusive, though not limited specifically. With the use of the positive electrode current collector 51 and the negative electrode current collector 62 having a thickness within the above range, the weight of the lithium ion secondary battery is reduced with the strength of the electrode plates maintained.

The thickness of the porous insulating layer 12 is preferably within the range between 10 μm and 40 μm, both inclusive, and more preferably within the range between 15 μm and 25 μm, both inclusive. The porosity of the porous insulating layer 12, which is a ratio of the volume of the porous part to the entire volume of the porous insulating layer 12, is preferably in the range between 30% and 70%, both inclusive, and more preferably, 35% and 60%, both inclusive. Preferably, the porosity is set with it taken into consideration that the nonaqueous electrolyte is retained in the pores and the lithium ion moves in the pores in charge.

The porous insulating layer 12 has a layered structure composed of a separator 7 and a metal oxide layer 11. The separator 7 is formed on the surface of the positive electrode mixture layer 52, and the metal oxide layer 11 is formed on the surface of the separator 7. Wherein, the pores in the separator 7 are not shown in FIG. 3 for the convenience sake. As the material of the separator 7, there may be used any of a micro-porous thin film, woven fabric, non-woven fabric, and the like which have large ion permeability and predetermined mechanical strength and insulating property. The material of the separator 7 is any of organic materials. Wherein, polyolefin, such as polypropylene, polyethylene, or the like enhances the durability of the separator 7, thereby leading to provision of a highly reliable lithium ion secondary battery.

The metal oxide layer 11, which is provided on the surface of the negative electrode mixture layer 62, is a porous layer in which a plurality of metal oxide particles 10, 10, . . . are bound to each other by means of a binder or the like. The metal oxide particles 10, 10, . . . are made of metal oxide other than metal oxide contributing to occlusion and extraction of the lithium ion, and is preferably a high melting-point material of which melting point is higher than that of the organic material (not shown) composing the separator 7. As the high melting-point material, there are alumina (aluminum oxide), titania (titanium oxide), zirconia (zirconium oxide), magnesia (magnesium oxide), zinc oxide, silica (silicon oxide), and the like, for example. Alumina is preferable and α-alumina is more preferable as a material of the metal oxide particles 10, 10, . . . There are three reasons why α-alumina is preferable. Namely: α-alumina is chemically stable, and high-purity α-alumina is chemically stable especially; α-alumina is less invaded by application of oxidation reduction potential and the electrolyte and causes less adverse effect adversely influencing the battery characteristics; and α-alumina is excellent in mechanical strength and effective insulation between the positive electrode 5 and the negative electrode 6 is exhibited in short circuit.

The metal oxide particles 10, 10, . . . are present in the metal oxide layer 11 so that the volume ratio thereof falls in the range between 15 vol % and 50 vol %, both inclusive, preferably, in the range between 30 vol % and 50 vol %, both inclusive. The volume ratio herein means a ratio of the total volume of the metal oxide particles 10, 10, . . . to the volume of the porous insulating layer 12. For example, when the volume ratio of the metal oxide particles 10, 10, . . . is 15 vol % and the porosity of the porous insulating layer 12 is 30%, the volume ratio of the separator 7 to the porous insulating layer 12 is 55 vol %.

The metal oxide particles 10, 10, . . . , which are a high melting-point material having a melting point higher than the organic material composing the separator 7, are not melted even if the separator 7 is melted upon temperature rise as a result of generation of much amount of Joule heat in overcharge. Consequently, in the lithium ion secondary battery in accordance with the present embodiment, the positive electrode 5 and the negative electrode 6 are prevented from being in contact with each other even if the separator 7 is melted to thus prevent spark from being caused in the battery. In detail, with the use of the olivine oxide as the positive electrode active material, the voltage abruptly rises after charge, as shown in FIG. 1, to generate much amount of Joule heat in overcharge to cause abrupt temperature rise. The shutdown mechanism of the separator 7 and the like might not be able to follow such abrupt temperature rise, so that the temperature reaches the melting point of the separator 7 to melt the separator 7. Nevertheless, since the melting point of the metal oxide particles 10, 10, . . . is higher than the melting point of the organic material of the separator 7, the metal oxide particles 10, 10, . . . are not melted even when the separator 7 is melted. This prevents contact between the positive electrode 5 and the negative electrode 6 to prevent spark from being caused in the battery.

When the volume ratio of the metal oxide particles 10, 10, . . . is below 15 vol %, melting of the separator 7 by overcharge or the like invites contact between the positive electrode 5 and the negative electrode 6 to cause spark in the battery. When the volume ratio of the metal oxide particles 10, 10, . . . exceeds 50 vol %, which means that the porosity of the porous insulating layer 12 is below 30 vol %, various problems are involved. Namely: the porous insulating layer 12 retains an insufficient amount of the electrolyte; the lithium ion moves not smoothly between the positive electrode 5 and the negative electrode 6 in charge; and the like. These factors invite lowering of the charging performance of the lithium ion secondary battery. For measuring the volume ratio of the metal oxide particles 10, 10, . . . , a method may be employed, for example, in which the weight of the metal oxide particles is measured with the use of a fluorescent X-ray and the volume of the metal oxide particles is calculated from the measured weight and the absolute specific gravity of the metal oxide particles.

The form of the metal oxide particles 10, 10, . . . is not limited specifically, but is not preferable to be in the form of a film. Because, a metal oxide film may cover the entire surface of the positive electrode mixture layer 52 or the negative electrode mixture layer 62 to increase the resistance at the surface of the positive electrode mixture layer 52 or the negative electrode mixture layer 62, thereby inviting performance lowering of the lithium ion secondary battery.

Preferably, the metal oxide particles 10, 10, . . . are in the form filled in the porous insulating layer 12 at not so high density. For example, it is preferable to be in the form of any of polycrystalline particles, particles, a plurality of particles bound to each other, fiber, and plural pieces of fibers bound to each other. Among all, the metal oxide in the form of polycrystalline particles is prevented the most from being filled in the porous insulating layer 12 at high density, and accordingly, the metal oxide layer 11 is preferably made of polycrystalline particles of the metal oxide. Wherein, metal oxide particles, a plurality of the metal oxide particles bound to each other, metal oxide fiber, or plural pieces of metal oxide fiber bound to each other may be included besides the polycrystalline particles of the metal oxide.

The polycrystalline particles of the metal oxide will be described below. As the polycrystalline particles of the metal oxide, the polycrystalline particles of metal oxide as disclosed in WO2005/124899 are preferable.

The polycrystalline particles each include preferably there or more, and more preferably, five to thirty single crystal cores in average. For example, when a SEM picture of five polycrystalline particles is taken by a scanning electron microscope and the number of single crystal cores included in each polycrystalline particle is counted in the SEM picture, it is preferable that the average thereof is three or more and is more preferable that five to thirty.

The diameter of the single crystal cores is preferably in the range between 0.05 μm and 1 μm, both inclusive. The grain diameter of the polycrystalline particles is small as the diameter of the single crystal cores is small. Accordingly, the space between the polycrystalline particles arranged adjacent to each other becomes small. When the diameter of the single crystal cores of the metal oxide particles 10, 10, . . . is below 0.05 μm, the space is so small that the diffusion rate of the lithium ion in the nonaqueous electrolyte lowers, thereby lowering the discharge performance remarkably. On the other hand, the grain diameter of the polycrystalline particles is large as the diameter of the single crystal cores is large to increase the space. When the diameter of the single crystal cores of the metal oxide particles exceeds 1 μm, the diameter of the pores in the porous insulating layer 12 increases excessively, thereby lowering the liquid (nonaqueous electrolyte) retaining capacity of the porous insulating material 12 to lower the discharge performance remarkably.

The polycrystalline particles as the metal oxide particles 10, 10, . . . are preferably prepared in such a manner that a precursor of the metal oxide is baked to obtain a baked solid of the metal oxide and the thus obtained baked solid of the metal oxide is crushed mechanically. The baked solid of the metal oxide is preferably in a form of comparatively large polycrystalline particles in which grown single crystal cores are bonded three-dimensionally. When such a baked solid is crushed mechanically, the obtained polycrystalline particles become comparatively small. The thus obtained comparatively small polycrystalline particles are filled into a void at not so high density. Accordingly, when the porous insulating layer 12 is formed of such metal oxide particles, the lithium ion secondary battery exhibits excellent discharge performance.

For obtaining metal oxide particles of high-purity α-alumina, aluminum ammonium salt or aluminum alkoxide is preferably used as the precursor of the metal oxide or the source material thereof. Aluminum alkoxide includes aluminum tributoxide and the like, for example. Aluminum ammonium salt includes ammonium dawsonite, ammonium alum, and the like, for example. The baked solid can be obtained by baking directly aluminum ammonium salt or aluminum alkoxide but is usually obtained by baking aluminum ammonium salt or aluminum alkoxide subjected to hydrolysis or the like. Aluminum ammonium salt and aluminum alkoxide have high purity, and accordingly, crystal growth of alumina is less inhibited by impurity in baking. As a result, single-crystal α-alumina baked solid of which core size are well averaged can be prepared.

The baked solid is preferably crushed by a dry grinding apparatus, such as a jet mill. Control of crushing condition attains ceramic powder having desired bulk density and specific surface area. The bulk density of the metal oxide particles 10, 10, . . . is preferably in the range between 0.1 g/m³, and 0.8 g/m³, both inclusive, more preferably, in the range between 0.3 g/m³ and 0.6 g/m³. When the bulk density thereof is below 0.1 g/m³, the porosity of the porous insulating layer increases while on the other hand the amount of the binder with respect to the specific surface area of the ceramic powder reduces, thereby inviting pealing off of the porous insulating layer from an electrode plate. When the bulk density thereof exceeds 0.8 g/m³, the amount of the binder increases while the porosity of the porous insulating layer reduces relatively, which is not preferable. The bulk density means a value measured by a static method.

The specific surface area of the ceramic powder is preferably in the range between 5 m²/g and 20 m²/g, both inclusive. The specific surface area thereof is a value measured by BET (Brunauer-Emmett-Teller).

The nonaqueous electrolyte (not shown) is retained in the porous insulating layer 12 and may be prepared by dissolving a supporting electrolyte in an organic solvent.

The organic solvent is not limited specifically only if it is usable as an electrolyte for a general lithium ion secondary battery and may be any of carbonate, halogenated hydrocarbon, ether, ketone, nitrile, lactone, oxiolane compounds, and the like, for example. It is preferable to use, as the organic solvent, any one of propylene carbonate, ethylene carbonate, 1,2-dimetoxyethane, dimethyl carbonate, diethyl carbonate, ethylmethyl carbonate, and the like, and a mixed solvent thereof. More preferably, at least one of nonaqueous electrolytes selected from the group consisting of carbonate and ether is used as the organic solvent. This attains desired solubility, dielectric constant, and viscosity of the supporting electrolyte, leading to enhancement of the charge/discharge efficiency of the battery.

The supporting electrolyte is not limited in kind specifically but is preferably at least one of: an inorganic salt selected from the group consisting of LiPF₆, LiBF₄, LiClO₄, and LiAsF₆; a derivative of the inorganic salt; an organic salt selected form the group consisting of LiSO₃CF₃, LiC(SO₃CF₃)₂, LiN(SO₃CF₃)₂, LiN(SO₂C₂F₅)₂, and LiN(SO₂CF₃)(SO₂C₄F₉); and a derivative of the organic salt. The use of such salt as the supporting electrolyte makes the battery performance more excellent and maintains the battery performance highly in a wide temperature range other than the room temperature. The concentration of the supporting electrolyte is not limited specifically and is preferably determined appropriately with the kinds of the supporting electrolyte and the organic solvent taken into consideration.

As described above, the olivine oxide does not cause decomposition reaction accompanying oxygen extraction even in a high temperature state. Accordingly, with the use of the olivine oxide as the positive electrode active material, decomposition of the positive electrode active material can be suppressed even in a high temperature state caused by overcharge or the like. Nevertheless, the olivine oxide as the positive electrode active material causes abrupt voltage rise after charge to melt the separator, thereby inviting contact between the positive electrode and the negative electrode. This causes spark in the battery, which is considerably dangerous.

Provision of the metal oxide layer 11 between the positive electrode 5 and the negative electrode 6 as in the lithium ion secondary battery in accordance with the present invention prevents the metal oxide particles 10, 10, . . . , of which melting point is higher than that of the organic material composing the separator 7, from being melted even if the separator 7 is melted. Hence, even if the separator 7 is melted by overcharge or the like, the positive electrode 5 and the negative electrode 6 are prevented from being in contact with each other to prevent spark from being caused in the lithium ion secondary battery.

The lithium ion secondary battery in accordance with the present embodiment may have the following structure.

The form of the lithium ion secondary battery is not limited to that shown in FIG. 2. Specifically, the lithium ion secondary battery may be in the form of an angular pole and may be of high-power output type. The positive electrode and the negative electrode are wound spirally with the separator interposed in the present embodiment, but the positive electrode and the negative electrode may be layered with the separator interposed.

There is no limitation to the above materials and numerical values on the positive electrode current collector, the negative electrode current collector, the positive electrode active material, the negative electrode active material, the conductive material, the binder, the organic solvent for the nonaqueous electrolyte, the solute of the nonaqueous electrolyte, the separator, the thicknesses of the positive electrode current collector, the negative electrode current collector, and the separator, the compounding ratios of the positive electrode mixture layer and the negative electrode mixture layer, and the like.

In the electrode group, the metal oxide layer, the separator, and the positive electrode are provided in this order on the negative electrode in the present embodiment, but the structure of the electrode group is not limited specifically. For example, in the electrode group; the metal oxide layer, the separator, and the negative electrode may be provided in this order on the positive electrode; the separator, the metal oxide layer, and the positive electrode may be provided in this on the negative electrode; the separator, the metal oxide layer, and the negative electrode may be provided in this order on the positive electrode; or a first separator, the metal oxide layer, a second separator, and the positive electrode are provided in this order on the negative electrode. The metal oxide layer may be provided on each or one of the surfaces of the electrode plates.

Further, the electrode group may have any of the structures described in Modified Example 1 and 2.

### Modified Example 1

FIG. 4 is an enlarged view of an electrode group in accordance with Modified Example 1 of the embodiment.

The electrode group 19 in the present modified example includes the positive electrode 5, the negative electrode 6, and the porous insulating layer 12, in which organic material particles 17 17, . . . and the metal oxide 10, 10 . . . are dispersed uniformly.

The organic material particles 17, 17, . . . compose the separator 7 in the embodiment and is preferably made of polyolefin, such as polypropylene, polyethylene, or the like. The form of the organic material particles 17, 17, . . . are not limited specifically, but is preferable to have substantially the same form as the metal oxide particles 10, 10, . . . in the embodiment. The metal oxide particles 10, 10, . . . are made of a high melting-point material having a melting point higher than that of the organic material particles 17, 17, . . . , and the organic material particles 17, 17, . . . and the metal oxide 10, 10, . . . are preferably bound to the surface of the positive electrode mixture layer 52 of the positive electrode 5 or the surface of the negative electrode mixture layer 62 of the negative electrode 6 by means of a binder.

With the above structure, when the temperature rises abruptly as a result of generation of much amount of Joule heat by abrupt voltage rise caused due to overcharge or the like, the organic material particles 17, 17, . . . are melted. However, the metal oxide particles 10, 10, . . . , which have a melting point higher than that of the organic material particles 17, 17, . . . , are not melted. This prevents the positive electrode 5 and the negative electrode 6 from being in contact with each other to prevent spark from being caused in the lithium ion secondary battery.

### Modified Example 2

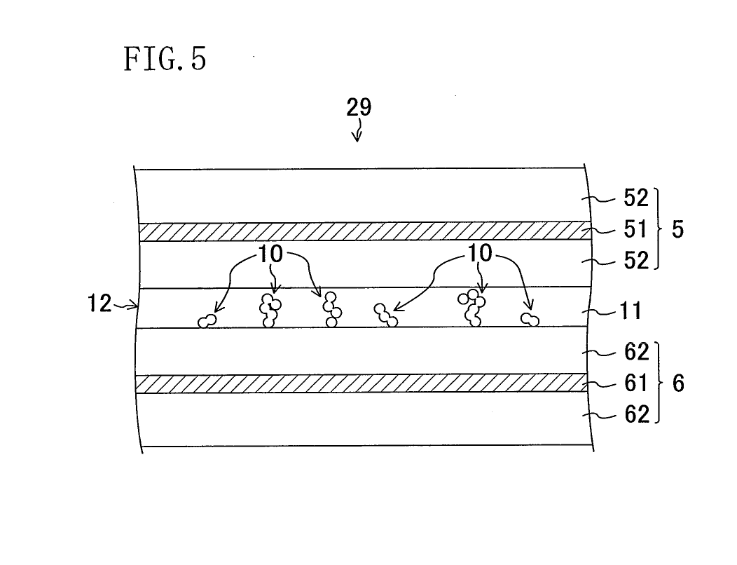

FIG. 5 is an enlarged view of an electrode group in accordance with Modified Example 2 of the embodiment.

The electrode group 29 in the present modified example includes the positive electrode 5, the negative electrode 6, and the porous insulating layer 12 formed of the metal oxide layer 11. In other words, there is neither a separator as in the embodiment nor organic material particles as in Modified Example 1 between the positive electrode 5 and the negative electrode 6.

With the above structure, the metal oxide particles 10, 10, . . . maintain the insulating property between the positive electrode 5 and the negative electrode 6 in normal operation and prevent the positive electrode 5 and the negative electrode 6 from being in contact with each other in overcharge and the like, thereby preventing spark from being caused in the battery.

### WORKING EXAMPLES

### Working Example 1

In Working Example 1, cylindrical lithium ion secondary batteries as shown in FIG. 2 were produced to be evaluated the safety thereof.

(Battery 1)

(Formation of Positive Electrode)

One kind of olivine oxide, LiFePO₄ was used as a positive electrode active material. First, the olivine oxide (positive electrode active material) of 100 weight %, graphite as a conductive material of 10 weight %, and PVDF (polyvynilidene difluororide) as a binder of 2 weight % were mixed with N-methyl-2-pyrolydone as a solvent to prepare a positive electrode paste.

Next, the thus prepared positive electrode paste was applied onto each surface of a current collector of an aluminum foil having a thickness of 30 μm to have a predetermined weight and a predetermined film thickness, was dried, and was pressed to have a predetermined film thickness. The thus formed electrode was cut into 52 mm wide and 1660 mm long, and a current taking lead tub was soldered to the thus cut electrode to obtain a positive electrode plate. In the tables and the specification, the unit “%” means a mass percentage and the ratio in the composition formula of the positive electrode active material means a mass ratio.

(Formation of Negative Electrode)

Mesophase microsphere graphitized at a high temperature of 2800° C. (hereinafter referred to it as mesophase graphite) was used as a negative electrode active material. First, the mesophase graphite of 100 weight %, SBR (styrene butadiene rubber) denatured by acrylic acid (BM-400B produced by ZEON Corporation) of 2.5 weight %, carboxymethyl cellulose of 1 weight %, and water of an appropriate amount were stirred to prepare a negative electrode paste.

Next, the thus prepared negative electrode paste was applied onto each surface of a current collector of a copper foil having a film thickness of 0.02 mm to have a predetermine weight and a predetermined film thickness, was dried, and was pressed to have a predetermined film thickness. The thus formed electrode was cut into 55 mm wide and 1730 mm long, and a current taking lead tub was soldered to the thus cut electrode to obtain a negative electrode.

(Preparation of Nonaqueous Electrolyte)

Ethylene carbonate and dimethyl carbonate were mixed at a volume ratio of 2:8 to prepare a solvent. Then, LiPF₆ was solved at a concentration of 1.5 mol/L in the thus prepared solvent to obtain an electrolyte.

(Preparation of Polycrystalline Ceramic Powder)

In the present modified example, α-alumina was used as polycrystalline particles to prepare ceramic powder of α-alumina.

Specifically, aluminum tributoxide as aluminum alkoxide was prepared first. Pure water was added to aluminum alkoxide to cause hydrolysis for generating alumina gel, and the thus generated alumina gel was dried. The thus obtained dried gel was used as a ceramic precursor.

Next, the ceramic precursor was baked at 1200° C. for three hours to obtain a baked solid of α-alumina. A SEM picture of the thus obtained baked solid was taken to find that the average grain diameter of the single crystal cores of α-alumina was approximately 0.2 μm.

Thereafter, the thus obtained baked solid was crushed by a jet mill to obtain ceramic powder having a bulk density of 0.1 g/cm³ and a BET specific surface area of 17 m²/g. Herein, the bulk density was measured by a static method using “POWDERTESTER” (trade name, produced by Hosokawa Micron Corporation), and the BET specific surface area was measured by BET. A SEM picture of the thus obtained ceramic powder confirmed that the ceramic powder is dendritic polycrystalline particles.

(Application of Metal Oxide)

First, polyacrylic derivative as a binder of four weight parts and N-methyl-2-pyrolydone as a dispersion medium (hereinafter referred to it as NPM) of an appropriate amount were mixed with a predetermined polycrystalline alumina particles of 100 weight parts to prepare slurry of which nonvolatile part is 60 weight %. Specifically, a mixture of the polycrystalline alumina particles, the binder, and NMP was stirred by a medialess distributor (“CLEAR MIX” (trade name) produced by M TECHNIQUE Corporation) until the polycrystalline alumina particles and the binder were dispersed in NMP uniformly.

Next, the thus obtained slurry was applied onto each surface of the negative electrode by gravure roll, and was dried by blowing hot air at a temperature of 120° C. at a blowing rate of 0.5 m/second.

(Production of Battery)

First, the positive electrode and the negative electrode to which alumina is applied are wound with a polyethylene-made separator having a thickness of 16 μm interposed to prepare an electrode plate group.

Next, both insulating plates and leads were provided on and below the electrode plate group. Then, the negative electrode lead was soldered to a battery case, the positive electrode lead was soldered to a sealing plate including a safety valve of inter pressure operated type, and then, the electrode plate group was inserted into the battery case.

Subsequently, the nonaqueous electrolyte is injected into the battery case by evacuation, and the opening of the battery case is calked to a sealing plate with a gasket interposed. Thus, Battery 1 is produced.

In Battery 1, the metal oxide layer provided on each surface of the negative electrode has a thickness of 8 μm. Battery 1 is provided with neither a PCT thermister nor a CID for interrupting current at temperature rise or voltage rise in overcharge.

The thus obtained cylindrical battery was measured to find that the battery capacity thereof was 2500 mAh. The battery capacity was measured after the battery was charged at a constant current of 2.5 A under a temperature of 25° C. until the voltage becomes 4.2 V, was charged at a constant voltage of 4.2 V until the current becomes 250 mA, and then, was discharged at a constant current of 250 mA until the voltage becomes 2.5 V.

(Battery 2)

Battery 2 was produced by the same method as the method by which Battery 1 was produced except that: a metal oxide layer having a thickness of 8 μm was provided on each surface of the positive electrode mixture layer while no metal oxide layer is provided on the surfaces of the negative electrode mixture layer; and the positive electrode and the negative electrode were wound with a polyethylene-made separator having a thickness of 16 μm interposed.

(Battery 3)

Battery 3 was produced by the same method as the method by which Battery 1 was produced except that: the thickness of the metal oxide layer on each surface was set to 24 μm; and the positive electrode and the negative electrode were wound with no separator interposed.

(Battery 4)

Battery 4 was produced by the same method as the method by which Battery 1 was produced except that: the metal oxide layer having a thickness of 24 μm was provided on each surface of the positive electrode mixture layer while no metal oxide layer is provided on the surfaces of the negative electrode mixture layer; and the positive electrode and the negative electrode were wound with no separator interposed.

(Battery 5)

Battery 5 was produced by the same method as the method by which Battery 1 was produced except that: the thickness of the metal oxide layer on each surface was set to 14 μm; and the thickness of the separator was set to 10 μm.

(Battery 6)

Battery 6 was produced by the same method as the method by which Battery 1 was produced except that: the metal oxide layer having a thickness of 14 μm was provided on each surface of the positive electrode mixture layer while no metal oxide layer is provided on the surfaces of the negative electrode mixture layer; and the positive electrode and the negative electrode were wound with a polyethylene-made separator having a thickness of 10 μm interposed.

(Battery 7)

Battery 7 was produced by the same method as the method by which Battery 1 was produced except that: the alumina particles were applied on neither surfaces of the positive electrode mixture layer and the negative electrode mixture layer; and the thickness of the separator was set to 24 μm.

(Battery 8)

Battery 8 was produced by the same method as the method by which Battery 1 was produced except that: the thickness of the metal oxide layer was set to 4 μm; and the thickness of the separator was set to 20 μm.

(Battery 9)

Battery 9 was produced by the same method as the method by which Battery 1 was produced except that: the metal oxide layer having a thickness of 4 μm was provided on each surface of the positive electrode mixture layer while no metal oxide layer is provided on the surfaces of the negative electrode mixture layer; and the positive electrode and the negative electrode were wound with a polyethylene-made separator having a thickness of 20 μm interposed.

(Volume Ratio of Alumina Particles to Porous Insulating Layer)

Prior to safety evaluation, each volume ratio of the alumina particles to the porous insulating layer were obtained in Battery 1 to Battery 9. Specifically, the weight of the metal oxide was measured with the use of a fluorescent X-ray, and the volume of the metal oxide was calculated from the measurement result and the true specific gravity of the metal oxide.

(Safety Evaluation)

Each five batteries A to E were prepared as Battery 1 to Battery 9 for safety evaluation. Specifically, after a constant current of 2.5 A was allowed to flow therein continuously for charge, change in temperature of the electrodes and external appearance of each battery were observed. Wherein, the upper limit voltage applied to the batteries was set to 60 V, and the temperatures of the surfaces of the batteries were measured when no abnormal external appearance was observed.

Table 1 indicates the measurement results of the volume ratios of the alumina particles and the results of the safety evaluation. In Table 1, the volume ratio means the volume ratio of the alumina particles. In the results of the safety evaluation, the temperature means the maximum temperature reaching, and “X” means observation of smoke from the battery, namely, the case where smoke from the inside of the battery generated due to operation of the explosion-proof valve was observed.

TABLE 1

| | Layer thickness (μm) | | | | | | | |
|---|---|---|---|---|---|---|---|---|
| | | Metal oxide | Volume | Safety evaluation (° C.) | | | | |
| | Separator | layer | ratio (%) | Battery A | Battery B | Battery C | Battery D | Battery E |
| Battery 1 | 16 | 8 | 15 | 120 | 118 | 118 | 110 | 117 |
| Battery 2 | 16 | 8 | 15 | 119 | 117 | 114 | 115 | 118 |
| Battery 3 | — | 24 | 50 | 125 | 123 | 130 | 130 | 128 |
| Battery 4 | — | 24 | 50 | 124 | 133 | 128 | 130 | 125 |
| Battery 5 | 10 | 14 | 30 | 105 | 107 | 105 | 105 | 103 |
| Battery 6 | 10 | 14 | 30 | 104 | 102 | 103 | 103 | 100 |
| Battery 7 | 24 | — | 0 | X | X | X | X | X |
| Battery 8 | 20 | 4 | 9 | X | X | X | X | X |
| Battery 9 | 20 | 4 | 9 | X | X | X | X | X |

As indicated in Table 1, no change in external appearance was observed in any of the batteries of Battery 1 to Battery 6 while smoke from the inside of the batteries was observed in Battery 7 to Battery 9.

The reason thereof might be the following. When the olivine oxide is used as the positive electrode active material, the voltage is constant and low in charge in normal use and rises abruptly in overcharge. The abrupt rise in voltage in overcharge causes the olivine oxide to generate Joule heat abruptly to raise the temperature of the battery abruptly, and the temperature rise in the battery is too abrupt for the current interrupting mechanism and the separator to stop the temperature rise in Battery 7 to Battery 9. Thus, in Battery 7, the separator was melted in the end to cause the positive electrode plate and the negative electrode plate to be in contact with each other, thereby raising the temperature of the battery further. As a result, smoke from the inside of the battery was observed.

Referring to Battery 8 and Battery 9, which are provided with the metal oxide layer, the alumina was added insufficiently. For this reason, these batteries might not be able to have a withstand voltage of 60 V, thereby generating heat.

On the other hand, Battery 1 to Battery 6 each include the metal oxide layer and have a sufficient volume ratio of the metal oxide. Accordingly, these batteries have a withstand voltage of 60 V or higher so that the positive electrode and the negative electrode were prevented from being in contact with each other even when the temperature of the battery rose.

Battery 1, Battery 2, Battery 5, and Battery 6 each include the separator while Battery 3 and Battery 4 includes no separator. Accordingly, the maximum temperature in overcharge was lower in Battery 1, Battery 2, Battery 5, and Battery 6 than in Battery 3 and Battery 4. Nevertheless, even with no separator, the current flowing between the positive electrode and the negative electrode was suppressed low in Battery 3 and Battery 4.

### Working Example 2

In Working Example 2, Battery 11 to Battery 14 were prepared by the same method as the method by which Battery 1 was prepared except that the alumina was added so that the bulk density and the BET specific surface area became the respective values indicated in Table 2.

Further, Battery 15 was prepared by the same method as the method by which Battery 1 was prepared except that the alumina particles of spherical or substantially spherical primary particles having an average grain diameter of 0.3 μm were used rather than the polycrystalline particles in chain. The bulk density and the BET specific surface area were measured by the same methods as those referred to in Working Example 1.

Then, safety evaluation was performed on Battery 11 to Battery 15, and the battery capacities of were measured.

(Safety Evaluation)

Each five batteries were prepared as Battery 11 to Battery 15 for safety evaluation. Specifically, after a constant current of 2.5 A was allowed to flow therein continuously for charge, change in temperature of the electrodes and external appearance of each battery were observed. Wherein, the upper limit voltage applied to the batteries was set to 60 V. The result was such that no smoke was observed in any of the batteries.

(Battery Performance Evaluation)

Each battery capacity of Battery 1 and Battery 11 to Battery 15 was measured after low rate discharge and high rate discharge. Battery capacity 1 in Table 2 is a capacity measured after the low rate discharge. Specifically, the batteries were charged at a constant current of 2.5 A under the temperature of 25° C. until the voltage became 4.2 V, were charged at a constant voltage of 4.2V until the current value became 250 mA, and were then discharged at a constant current of 250 mA until the voltage became 2.5 V. Thereafter, the capacities were measured.

Battery capacity 2 in table 2 is a battery capacity measured after the high rate discharge. Specifically, Battery capacity 2 is a value after discharge at a constant current of 10 A until the voltage became 2.5 V after the low rate discharge.

The measurement results are indicated in Table 2.

TABLE 2

| | | | | Battery capacity | |
|---|---|---|---|---|---|
| | | Bulk | BET specific | (Ah) | |
| | | density | surface | Battery | Battery |
| | Form | (g/cm³) | area (m²/g) | capacity 1 | capacity 2 |
| Battery 1 | Chain | 0.1 | 17 | 2.60 | 2.58 |
| Battery 11 | Chain | 0.05 | 22 | 2.60 | 2.50 |
| Battery 12 | Chain | 0.4 | 9 | 2.60 | 2.50 |
| Battery 13 | Chain | 0.8 | 5 | 2.60 | 2.30 |
| Battery 14 | Chain | 1.1 | 3 | 2.50 | 2.10 |
| Battery 15 | Spherical | 1.1 | 3 | 2.20 | 1.50 |

As indicated in Table 2, Battery 11 to Battery 13 are almost the same as Battery 1 in Battery capacity 1 while Battery 14 and Battery 15 are smaller than Battery 1 therein. This might result from the fact that appropriate size of the pores in the porous insulating layer cannot be secured due to an increase in bulk density and a decrease in specific surface area.

Referring to Battery capacity 2, Battery 1 exhibits the maximum value, and the capacity value lowers according to the decrease in bulk density and the increase in BET specific surface area. The lowering rate is larger in Battery capacity 2 than in Battery 1. In other words, lowering of the battery capacity caused due to an increase in bulk density and a decrease in specific surface area is more remarkable in the high rate discharge than in the low rate discharge. The reason thereof might be the following. Lowering of the bulk density increases the size of the pores in the porous insulating layer to make the porous insulating layer to less retain the electrolyte, and accordingly, the lithium ion is diffused less in the nonaqueous electrolyte in the high rate discharge than in the low rate discharge, thereby lowering the battery capacity.

As described above, the measurement results and the evaluation results in the present working example proves that: the positive electrode and the negative electrode are prevented from being in contact with each other in Battery 1 and Battery 11 to Battery 15 even in a high temperature state caused by overcharge or the like; and lowering of the battery capacity caused due to the presence of the metal oxide layer can be suppressed in Battery 1 and Battery 11 to Battery 14 in contrast to Battery 15.

What is claimed is:

1. A nonaqueous electrolyte secondary battery, comprising:
a positive electrode containing, as a positive electrode active material, a phosphoric compound having an olivine structure and expressed by a general formula of Li_{z}Fe_{1-y}X_{y}PO₄ (0≦y≦0.3, 0<z≦1) (X is one of metals selected from the group consisting of Nb, Mg, Ti, Zr, Ta, W, Mn, Ni, and Co);
a negative electrode containing, as a negative electrode active material, a material capable of occluding and extracting lithium ion;
a nonaqueous electrolyte retained between the positive electrode and the negative electrode; and
a porous insulating layer provided between the positive electrode and the negative electrode and containing metal oxide,
wherein a volume ratio of the metal oxide to the porous insulating layer is in a range between 15 vol % and 50 vol %, both inclusive.

2. The nonaqueous electrolyte secondary battery of claim 1,
wherein the porous insulating layer is a metal oxide layer made of the metal oxide.

3. The nonaqueous electrolyte secondary battery of claim 1,
wherein the porous insulating layer further contains an organic material, and
the metal oxide has a melting point higher than the organic material.

4. The nonaqueous electrolyte secondary battery of claim 3,
wherein the porous insulating layer has a layered structure composed of a metal oxide layer made of the metal oxide and a separator made of the organic material.

5. The nonaqueous electrolyte secondary battery of claim 3,
wherein the metal oxide and the organic material are mixed in the porous insulating layer.

6. The nonaqueous electrolyte secondary battery of claim 2,
wherein the metal oxide layer is formed of particles of the metal oxide bound to each other.

7. The nonaqueous electrolyte secondary battery of claim 1,
wherein the metal oxide layer is provided on a surface of at least one of the positive electrode and the negative electrode.

8. The nonaqueous electrolyte secondary battery of claim 1,
wherein the metal oxide is aluminum oxide.
